(19) United States
(12) Patent Application Publication
(10) Pub. No.: US 2011/0005724 A1
(43) Pub. Date: Jan. 13, 2011

(54) HEAT TRANSPORT DEVICE MANUFACTURING METHOD AND HEAT TRANSPORT DEVICE

(75) Inventors: Hiroto Kasai, Tokyo (JP); Hiroyuki Ryoson, Tokyo (JP); Takashi Yajima, Tokyo (JP); Koji Hirata, Tokyo (JP)

Correspondence Address: SNR DENTON US LLP, P.O. BOX 061080, CHICAGO, IL, 60606-1080, US

(73) Assignees: SONY CORPORATION, Tokyo (JP); SONY CHEMICAL & INFORMATION DEVICE CORPORATION, Tokyo (JP)

(21) Appl. No.: 12/867,967

(22) PCT Filed: Dec. 11, 2009
(86) PCT No.: PCT/JP2009/006819

§ 371 Date: Aug. 17, 2010

(30) Foreign Application Priority Data
Dec. 24, 2008 (JP) 2008-328868

(51) Int. Cl. F28D 15/02; B32B 37/02

(52) U.S. Cl. 165/104.21; 156/308.2

(57) ABSTRACT

[Object] To provide a heat transport device manufacturing method and a heat transport device that has a high hermeticity and is manufactured without increasing a load applied at a time of performing diffusion bonding.

[Solving Means] A bonding surface (1a) of an upper member (1) that is subjected to diffusion bonding to a bonding surface (21) of a frame member (2) is formed into a convex shape, which can make a contact area of the bonding surface (1a) and the bonding surface (21) small. Therefore, a pressure (load per unit area) applied to the bonding surfaces (1a and 21) is increased, and thus the diffusion bonding of the bonding surfaces (1a and 21) is performed by a high pressure. Similarly, a bonding surface (3a) of a lower member (3) and a bonding surface (23) of the frame member (2) are also subjected to the diffusion bonding by a high pressure. As a result, a heat transport device (100) having a high hermeticity can be manufactured without increasing an entire load (F) applied at the time of the diffusion bonding.

### TECHNICAL FIELD

The present invention relates to a heat transport device manufacturing method and a heat transport device for transporting heat by a phase change of a working fluid.

### BACKGROUND ART

To cool an electronic apparatus such as a personal computer, there is being used a cooling device such as a heat pipe that absorbs heat generated from an electronic apparatus and transports the heat to a heat radiation portion, thereby radiating the heat.

In this cooling device, a working fluid contained therein evaporates due to the heat absorbed. The vapor moves to the low-temperature heat radiation portion and condenses, with the result that the heat is radiated. Thus, the electronic apparatus is cooled.

In recent years, along with miniaturization and reduction in thickness of an electronic apparatus or the like, a heat generation from an IC or the like included in the electronic apparatus becomes a significant problem. As means for solving the problem, a miniaturized, thin, and low-cost cooling device having high efficiency is being demanded.

Patent Document 1 discloses a diffusion bonding process in which an upper cover and a lower cover that constitute a heat spreader are subjected to diffusion bonding. As conditions set for the diffusion bonding, the diffusion-bonding temperature, pressure, and time are given (paragraphs [0023], [0024], [0026], [0033], FIG. 7 to 13).

### Citation List

### Patent Document

Patent Document 1: Japanese Patent Application Laid-open No. 2006-140435

### DISCLOSURE OF THE INVENTION

### Problem to be Solved by the Invention

Incidentally, to increase the hermeticity of the inside of a cooling device, it is necessary to increase a load applied to the cooling device in the diffusion bonding process. However, it is difficult to uniformly apply a large load. Therefore, unevenness of the load applied to the cooling device may occur in some cases, causing unevenness in a bonding state of the upper cover and the lower cover, with the result that the hermeticity of the cooling device may be impaired.

In view of the above-mentioned circumstances, the present invention has an object to provide a heat transport device manufacturing method and a heat transport device that has a high hermeticity and is manufactured without increasing the load applied at the time of the diffusion bonding.

### Means for Solving the Problem

To achieve the object mentioned above, a method of manufacturing a heat transport device according to an embodiment of the present invention includes causing a convex bonding surface of a first plate that forms a container of a heat transport device to be opposed to a bonding surface of a second plate that forms the container, the heat transport device transporting heat by using a phase change of a working fluid, the convex bonding surface forming a part of a sidewall that surrounds an inside space of the container.

Diffusion bonding is performed on the bonding surface of the first plate to the bonding surface of the second plate, to form the container.

The convex bonding surface for forming the part of the sidewall of the container by performing the diffusion bonding to the bonding surface of the second plate is annularly provided to the first plate. Because the bonding surface of the first plate has a convex shape, the contact area between the bonding surface of the first plate and the bonding surface of the second plate becomes small in the diffusion bonding process. Therefore, a large pressure (load per unit area) is applied to the bonding surface of the first plate and the bonding surface of the second plate, and the diffusion bonding is performed on the bonding surface of the first plate and the bonding surface of the second plate by the high pressure. As a result, the heat transport device having a high hermeticity can be manufactured without increasing the entire load applied at the time of the diffusion bonding.

The first plate may include a plurality of convex bonding surfaces.

The plurality of convex bonding surfaces provided on the first plate are subjected to the diffusion bonding with the bonding surface of the second plate by the high pressure, thereby forming the part of the sidewall of the container. The plurality of the convex bonding surfaces that function as the part of the sidewall multiply surrounds the inside space of the container, with the result that a leak failure rate can be lowered.

The diffusion bonding process may deform the plurality of convex bonding surfaces.

The high pressure applied in the diffusion bonding process makes the width of the convex bonding surface that forms the part of the sidewall of the container larger. As a result, the hermeticity of the heat transport device can be increased.

The plurality of convex bonding surfaces deformed may have a total width of 100 μm to 1 cm.

The method of manufacturing a heat transport device may further include forming the convex bonding surface by one of a mechanical polishing, an etching, and a molding process.

A method of manufacturing a heat transport device according to another embodiment of the present invention may include causing a convex bonding surface of a first plate that forms a container of a heat transport device to be opposed to a first bonding surface of a frame member that forms a sidewall that surrounds an inside space of the container, the heat transport device transporting heat by using a phase change of a working fluid, the convex bonding surface forming a part of the sidewall.

A bonding surface of a second plate that forms the container is caused to be opposed to a second bonding surface of the frame member, the second bonding surface being on an opposite side to the first bonding surface.

Diffusion bonding is performed on the bonding surface of the first plate to the first bonding surface, and diffusion bonding is performed on the bonding surface of the second plate to the second bonding surface, to form the container.

The process of causing the bonding surface of the first plate to be opposed to the first bonding surface of the frame member and the process of causing the bonding surface of the second plate to be opposed to the second bonding surface of the frame member may be performed at the same time or may be performed sequentially.

The bonding surface of the second plate is formed to be convex to form the part of the sidewall.

With this structure, the diffusion bonding between the first plate and the frame member and between the second plate and the frame member is performed by the high pressure without increasing the load applied in the diffusion bonding process.

A method of manufacturing a heat transport device according to another embodiment of the present invention includes causing a bonding surface of a first plate that forms a container of a heat transport device to be opposed to a convex first bonding surface of a frame member that forms a sidewall that surrounds an inside space of the container, the heat transport device transporting heat by using a phase change of a working fluid, the convex first bonding surface forming a part of the sidewall.

A bonding surface of a second plate that forms the container is caused to be opposed to a second bonding surface of the frame member, the second bonding surface being on an opposite side to the first bonding surface.

Diffusion bonding is performed on the bonding surface of the first plate to the first bonding surface, and diffusion bonding is performed on the bonding surface of the second plate to the second bonding surface, to form the container.

The second bonding surface of the frame member may be formed to be convex to form the part of the sidewall.

A method of manufacturing a heat transport device according to another embodiment of the present invention includes layering a jig portion, a first plate, and a second layer so that a bonding surface of the first plate that forms a container of a heat transport device is caused to be opposed to a bonding surface of the second plate that forms the container and an annular convex portion of the jig portion is caused to face the first plate from an opposite side of the bonding surface of the first plate, the heat transport device transporting heat by using a phase change of a working fluid, the convex first bonding surface forming a part of the sidewall.

By applying a load to the jig portion, the first plate, and the second plate in a direction of the layering, the bonding surface of the first plate is formed to be convex by the convex portion so that the bonding surface of the first plate is formed as a part of a sidewall that surrounds an inside space of the container.

Diffusion bonding is performed on the bonding surface of the first plate to the bonding surface of the second plate by using the load to form the container.

The high pressure is applied to the bonding surface of the first plate with the annular convex portion of the jig portion, and the bonding surface of the first plate is formed to be convex to function as the part of the sidewall of the container. In addition, the bonding surface of the first plate and the bonding surface of the second plate are subjected to the diffusion bonding by the high pressure.

A method of manufacturing a heat transport device according to another embodiment of the present invention includes sandwiching a capillary member by a first portion and a second portion of a plate by bending the plate, the plate forming a container of a heat transport device that transports heat by using a phase change of a working fluid, the capillary member applying a capillary force to the working fluid.

A convex bonding surface formed on the first portion is caused to be opposed to a bonding surface of the second portion to form a part of a sidewall that surrounds an inside space of the container.

Diffusion bonding is performed on the bonding surface of the first portion to the bonding surface of the second portion to form the container.

With this structure, because the one plate is bent to form the container, the number of parts is reduced, which can cut the cost. Further, in a case where the container is constituted of a plurality of parts, predetermined positioning accuracy of the parts is necessary. But, in this embodiment, such high positioning accuracy is unnecessary.

A heat transport device according to an embodiment of the present invention includes a container and a working fluid.

The container has a sidewall surrounding an inside space, and includes a first plate and a second plate, the first plate having a convex bonding surface to form a part of the sidewall, the second plate being bonded to the convex bonding surface by diffusion bonding.

The working fluid transports heat by a phase change in the container.

In a heat transport device according to another embodiment of the present invention, a container has a sidewall surrounding an inside space and includes a first plate, a frame member, and a second plate.

The first plate has a convex bonding surface to form a part of the sidewall.

The frame member has a first bonding surface bonded to the convex bonding surface by diffusion bonding and forming the sidewall.

The second plate is bonded to the second bonding surface by diffusion bonding, the second bonding surface being on an opposite side to the first bonding surface of the frame member.

The second plate may have a convex bonding surface to form the part of the sidewall, the convex bonding surface being bonded to the second bonding surface of the frame member by the diffusion bonding.

### EFFECT OF THE INVENTION

As described above, according to the present invention, a heat transport device having the high hermeticity is manufactured without increasing the load applied at the time of the diffusion bonding.

### BRIEF DESCRIPTION OF DRAWINGS

FIG. 1 A schematic cross-sectional view showing a heat transport device according to a first embodiment.

FIG. 2 A schematic exploded perspective view showing the heat transport device according to the first embodiment.

FIG. 3 Partial enlarged views of the heat transport device shown in FIG. 1.

FIG. 4 Diagrams for explaining a method of manufacturing a heat transport device according to the first embodiment.

FIG. 5 Schematic diagrams each showing a contact area Z between a convex bonding surface of an upper plate member and a bonding surface of a frame member.

FIG. 6 A schematic cross-sectional view for explaining a heat transport device having a void, which is assumed for a simulation.

FIG. 7 A graph obtained by performing a simulation of a leak rate with respect to a leak path.

FIG. 8 Diagrams for explaining a method of manufacturing a heat transport device according to a second embodiment.

FIG. 9 Diagrams for explaining a method of manufacturing a heat transport device as a comparison target.

FIG. 10 A graph for explaining a bonding process in a case where two members are subjected to the diffusion bonding.

FIG. 11 A graph showing a relationship among a pressure, a bonding rate, and a bonding mechanism that provides the greatest contribution rate with a temperature being constant.

FIG. 12 Diagrams for explaining a method of manufacturing a heat transport device according to a third embodiment.

FIG. 13 A diagram for explaining a method of manufacturing a heat transport device according to a fourth embodiment, in which a jig portion is used.

FIG. 14 A diagram for explaining a method of manufacturing a heat transport device according to a fifth embodiment.

FIG. 15 Diagrams each showing an example of a specific shape of the convex bonding surface.

FIG. 16 Diagrams each showing a modified example of the embodiments of the present invention.

FIG. 17 A schematic cross-sectional view showing the heat transport device according to the first embodiment, in which a heat source is disposed on a side close to a gas phase side.

FIG. 18 A perspective view showing a heat transport device according to further another embodiment of the present invention.

FIG. 19 A cross-sectional view of the heat transport device taken along the line A-A of FIG. 18.

FIG. 20 A development view of a plate member that forms a container of the heat transport device shown in FIG. 18.

FIG. 21 Diagrams showing a method of manufacturing a heat transport device according to further another embodiment.

FIG. 22 A development view of the plate member for explaining a heat transport device according to a modified example.

FIG. 23 A perspective view showing a heat transport device according to further another embodiment.

FIG. 24 A cross-sectional view of the heat transport device taken along the line A-A of FIG. 23.

FIG. 25 A development view of a plate member that forms a container of a heat transport device according to further another embodiment.

### BEST MODES FOR CARRYING OUT THE INVENTION

Hereinafter, an embodiment of the present invention will be described with reference to the drawings.

### Heat Transport Device According to First Embodiment

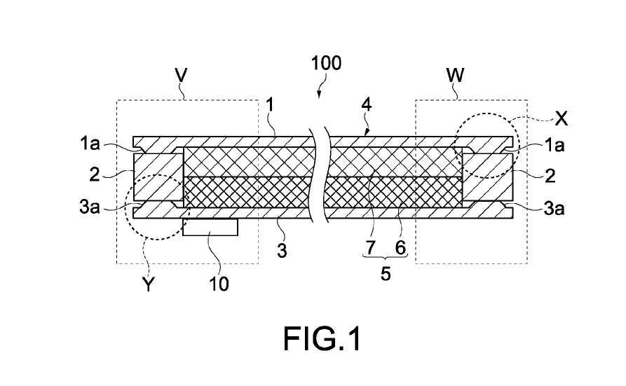

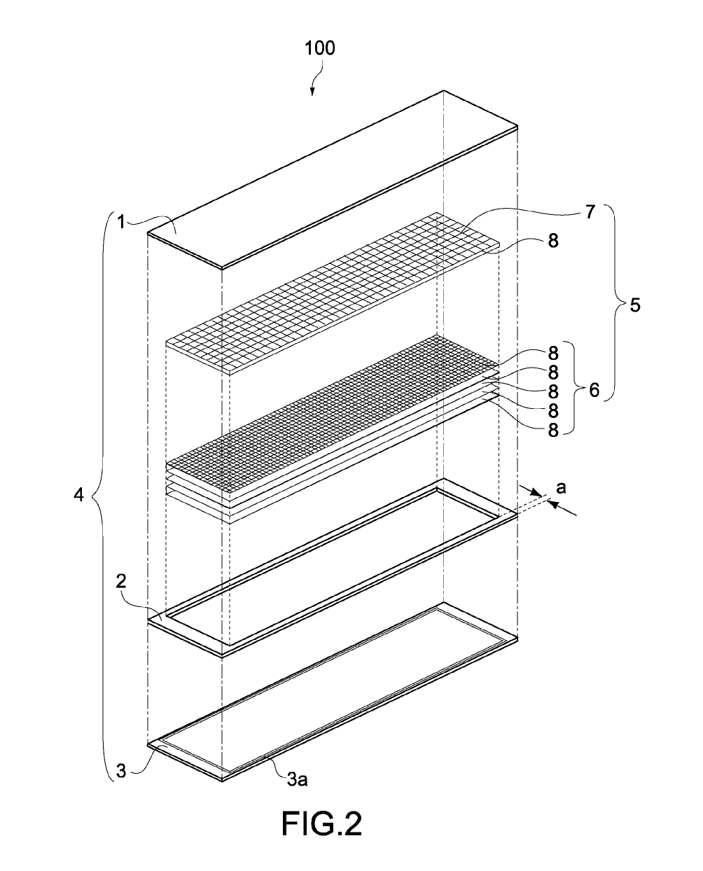

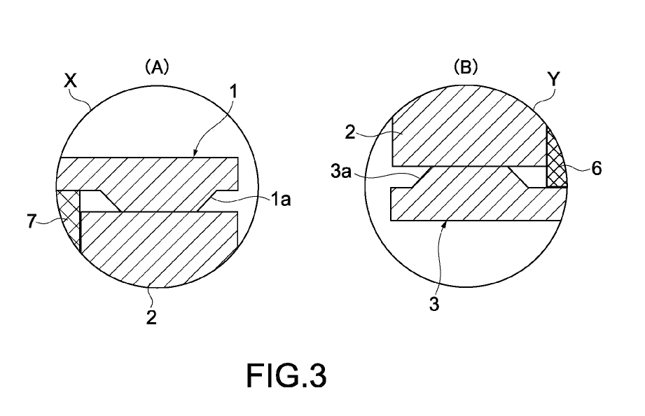

FIG. 1 is a schematic cross-sectional view showing a heat transport device according to a first embodiment of the present invention. FIG. 2 is an exploded perspective view thereof, and FIG. 3 are enlarged views showing reference symbols X and Y of FIG. 1. The cross-sectional view of FIG. 1 is a cross-sectional view taken along a longitudinal direction of a heat transport device 100. In the following, the same holds true for a direction in which a cross-sectional view is taken.

The heat transport device 100 includes a container 4 and a capillary member 5 provided in the container 4. The container 4 is constituted of an upper plate member 1, a frame member 2, and a lower plate member 3. The frame member 2 forms a sidewall that surrounds the inside space of the container 4.

In the container 4, a working fluid (not shown) that transports heat by a phase change is sealed in, and the capillary member 5 that applies a capillary force to the working fluid is provided. The capillary member 5 includes a first mesh layer 6 and a second mesh layer 7 layered on the first mesh layer 6. The second mesh layer 7 is made of a looser mesh than a mesh in the first mesh layer 6.

As the working fluid, pure water, ethanol, an alternative to chlorofluorocarbons, or the like is used.

As the material of the upper plate member 1, the frame member 2, and the lower plate member 3 that constitute the container 4, copper is typically used. In addition to this, nickel, aluminum, stainless steel, or the like may be used. The thickness of the upper plate member 1 and the lower plate member 3 is typically set to 0.1 mm to 0.8 mm. The thickness of the frame member 2 is typically set to 0.1 mm to 0.25 mm, and as shown in FIG. 2, a width a thereof is typically set to 2 mm to 1 cm. The materials and numerical values are not limited to those given as the typical examples herein. The same holds true for the following description.

As shown in FIG. 2, the first mesh layer 6 and the second mesh layer 7 are formed of one or more mesh members 8 each having a reticulate mesh of metal thin wires in a layered manner. In this embodiment, as the first mesh layer 6, two to five mesh members 8 are layered, and above the first mesh layer 6, one mesh member 8 is layered as the second mesh layer 7. The plurality of mesh members 8 are layered by brazing, bonding with an adhesive, a plating process, or the like. The thickness of each of the mesh members 8 is typically set to 0.02 mm to 0.05 mm.

During a non-operating time of the heat transport device 100, the working fluid is mainly attracted by the first mesh layer 6 having a larger capillary force and is held therein, out of the first mesh layer 6 and the second mesh layer 7.

As the capillary member 5, a member other than the mesh layer may be used. For example, a bunch of a plurality of wires may be used. However, any member may be used as long as the capillary force is applied to the working fluid. In addition, the capillary member 5 may not be used for a flow path of the working fluid in the gas phase. That is, in a thickness direction of the container 4, the capillary member 5 may be disposed up to the half of the height of the inside space of the container 4 from the bottom surface, and the capillary member 5 may not be disposed in the other half, for example.

As shown in FIG. 3, the upper plate member 1 and the lower plate member 3 are provided with convex bonding surfaces 1a and 3a, respectively. The bonding surfaces 1a and 3a are formed by a mechanical polishing, an etching, a molding process, or the like. As the etching, etching techniques such as an RIE (Reactive Ion Etching) and a dry etching using chemical agents (for example, sulfuric acid and hydrogen peroxide water) are used. In addition, as the molding process, a press process, a casting process, or the like is used. With those techniques, the cost in the manufacture of the heat transport device 100 can be cut.

The operation of the heat transport device 100 will be described. In a heat absorption portion V (see, FIG. 1) of the heat transport device 100, the liquid-phase working fluid receives heat from a heat source 10 such as a circuit device and thus evaporates. The gas-phase working fluid moves to a heat radiation portion W mainly through the second mesh layer 7 and radiates the heat in the heat radiation portion W to condense. The liquid-phase working fluid receives the capillary force by the first mesh layer 6, moves to the heat absorption portion V, and receives the heat from the heat source 10 to evaporate again. The repetition of this cycle causes the heat source 10 to be cooled.

It should be noted that, in FIG. 1, the example in which the heat source 10 is disposed on the side closer to the liquid phase side in the heat transport device 100, that is, the side closer to the first mesh layer 6 is shown. However, because the heat transport device 100 has a thin plate shape, the heat transport device 100 can exert high heat transport performance even when the heat source 10 may be disposed on the side closer to the gas phase side in the heat transport device 100, that is, the side closer to the second mesh layer 7 as shown in FIG. 17, for example.

[Method of Manufacturing Heat Transport Device 100]

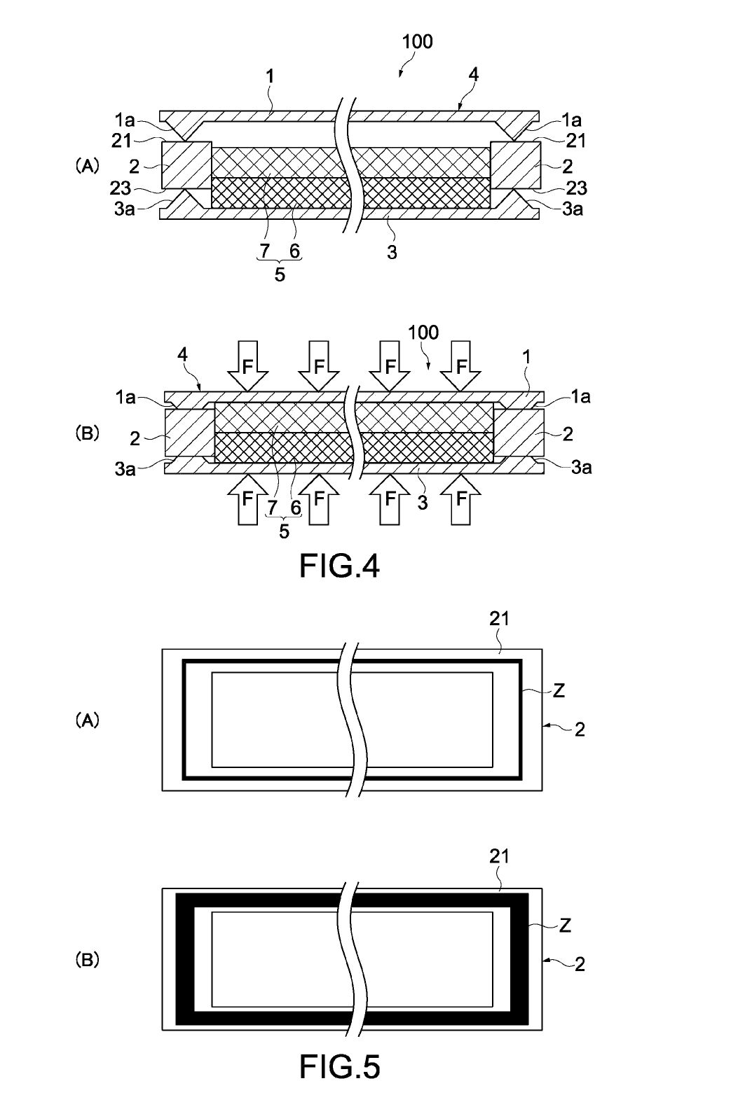

FIG. 4 are diagrams for explaining a method of manufacturing the heat transport device 100. As shown in FIG. 4(A), for example, the lower plate member 3 is placed on a table of a bonding apparatus (not shown), the frame member 2 and the capillary member 5 are placed on the lower plate member 3, and the upper plate member 1 is placed on the frame member 2. In this case, the convex bonding surface 1a of the upper plate member 1 is opposed to a bonding surface 21 of the frame member 2, which is bonded to the upper plate member 1. Further, the convex bonding surface 3a of the lower plate member 3 is opposed to a bonding surface 23 of the frame member 2, which is bonded to the lower plate member 3.

FIG. 5(A) is a schematic diagram showing a contact area Z of the bonding surface 1a and the bonding surface 21 at a time when the convex bonding surface 1a of the upper plate member 1 and the bonding surface 21 of the frame member 2 are opposed to each other in FIG. 4(A). A contact area of the bonding surface 3a and the bonding surface 23 is similar to this. As shown in FIG. 5(A), the bonding surface 1a is formed into the convex shape, with the result that the contact area Z of the bonding surface 1a and the bonding surface 21 can be made smaller.

As shown in FIG. 4(B), an entire load F is uniformly applied from both of the upper plate member 1 side and the lower plate member 3 side with the upper plate member 1, the frame member 2, and the lower plate member 3 being heated. With this operation, the bonding surfaces 1a and 3a are subjected to the diffusion bonding to the frame member 2. The bonding surfaces 1a and 3a are annularly provided on the upper plate member 1 and the lower plate member 3, respectively (see, reference symbol 3a of FIG. 2). The bonding surfaces 1a and 3a are subjected to the diffusion bonding with the frame member 2, thereby forming a part of the sidewall of the container 4.

FIG. 5(B) is a schematic diagram showing the contact area Z of the bonding surface 1a and the bonding surface 21 that have been subjected to the diffusion bonding in FIG. 4(B). As shown in FIG. 5(B), in the diffusion bonding process shown in FIG. 4(B), the bonding surface 1a is deformed, thereby increasing the width. As a result, the hermeticity of the heat transport device 100 is enhanced.

As described with reference to FIG. 5(A), by forming the bonding surface 1a into the convex shape, the contact area Z of the bonding surface 1a and the bonding surface 21 can be made smaller. Therefore, the pressure (load per unit area) applied to the bonding surfaces 1a and 21 is increased, and thus the bonding surfaces 1a and 21 are subjected to the diffusion bonding by a high pressure. In the same way, the bonding surfaces 3a and 23 are also subjected to the diffusion bonding by a high pressure. As a result, in the diffusion bonding process shown in FIG. 4(B), the heat transport device 100 having the high hermeticity can be manufactured without increasing the entire load F.

In this embodiment, the upper plate member 1 and the lower plate member 3 are provided with the convex bonding surfaces 1a and 3a, respectively, but the form of the bonding surfaces is not limited to this. A structure in which one of the upper plate member 1 and the lower plate member 3 has the convex bonding surface can also provide the above-described effect unique to this embodiment.

The inventors of the present invention have studied the widths of the deformed bonding surfaces 1a and 3a based on the following simulation.

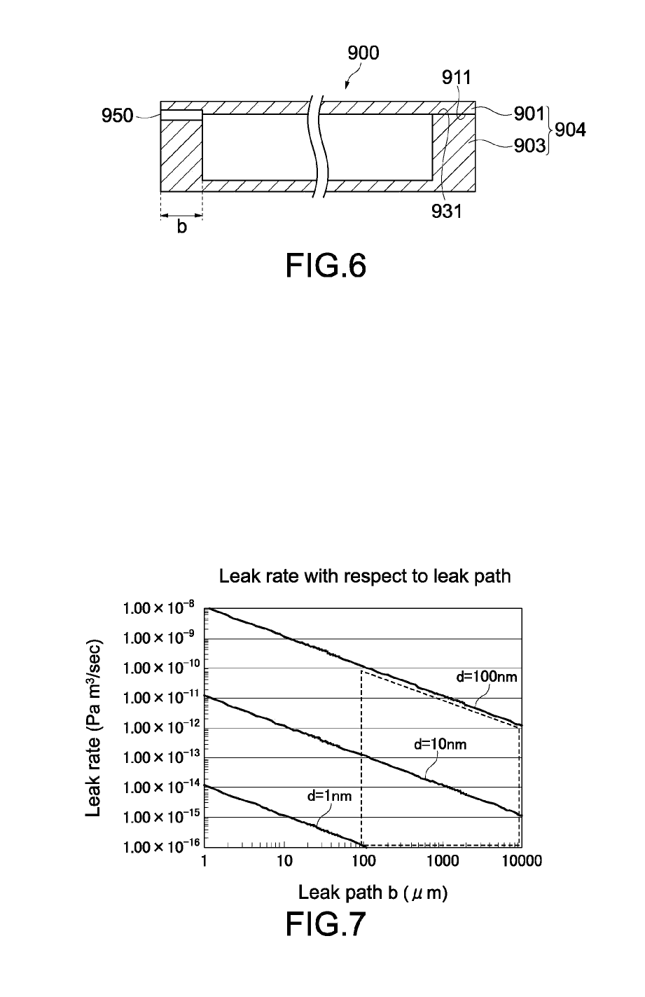

FIG. 6 is a schematic cross-sectional view for explaining a heat transport device having a void, which is assumed for a simulation. In the following, a capillary member is not shown in the figure.

A heat transport device 900 includes a container 904 constituted of an upper plate member 901 and a lower plate member 903 having a vessel shape. On a bonded portion of the upper plate member 901 and the lower plate member 903, a void 950 having a cylindrical shape whose diameter is set to d (nm) is formed. A leak rate that is generated due to the void 950 is simulated. The length of the void 950 is equal to a width b of a sidewall and is set to be a leak path b.

FIG. 7 is a graph obtained by performing a simulation of the leak rate with respect to the leak path b. The pressure of the inside space of the container 904 is set to 0.03 atm, which is almost the same as a vapor pressure of 25° C. water. The outside of the container 904 is an atmosphere. Under those conditions, the leak rates in cases where the diameter d of the void 950 is set to 100 nm, 10 nm, and 1 nm are simulated. The value of 100 nm set as the diameter d is a numerical value based on an actual measured value of an average height of the unevenness of a general member due to the roughness of its surface, which is used for manufacturing a heat transport device. That is, in the simulation in this case, the void having the diameter d of 100 nm is assumed as a void that is caused due to the roughness of the surface of a bonding surface 911 and a bonding surface 931.

When the leak rate is equal to or lower than 1.00*10⁻¹⁰ Pa·m³/sec, which is a measurement limit of a general He leak detector, it is judged that the leak is not caused. In a range in which the leak rate of He having a small molecular diameter and a small weight is equal to or smaller than 1.00*10⁻¹⁰ Pa·m³/sec, the hermeticity of the heat transport device 900 is not impaired.

As shown in the graph of FIG. 7, in a range in which the leak path b is 100 μm to 10000 μm (1 cm), the leak rate becomes less than 1.00*10⁻¹⁰ Pa·m³/sec (area surrounded by the broken line). That is, when the leak path b is 100 μm to 1 cm, the hermeticity of the heat transport device 900 is not impaired.

The above case is considered as to the heat transport device 100. The assumption is made that in the diffusion bonding process of FIG. 4(B), a void (void having the diameter d of 100 nm) is caused on a bonded portion of the bonding surface 1a of the upper plate member 1 and the bonding surface 21 of the frame member 2 due to the roughness of the surface of the bonding surface 1a and the bonding surface 21. However, if the width of the bonding surface 1a deformed in the diffusion bonding process is 100 μm to 1 cm, the leak path of the void generated is also 100 μm to 1 cm, preventing the hermeticity of the heat transport device 100 from being impaired.

Further, in the diffusion bonding process shown in FIG. 4(B), because the high pressure is applied to the bonding surfaces 1a and 21, it is thought that the height of the unevenness due to the roughness of the surface of the bonding surfaces 1a and 21 becomes smaller, which may also reduce the diameter d of the void caused due to the roughness of the surface. In this case, the leak rate becomes small. Therefore, the hermeticity of the heat transport device 100 is sufficiently maintained by the bonding surface 1a having the width in the above-mentioned range.

The above description is not intended to limit the width of the bonding surface 1a in the above-mentioned range. The width may be set as appropriate in such a range that the hermeticity of the heat transport device 100 is maintained.

Next, a description will be given on a relationship between the entire load and the pressure in the diffusion bonding process in a method of manufacturing a heat transport device according to embodiments of the present invention.

[Method of Manufacturing Heat Transport Device According to Second Embodiment]

FIG. 8 are diagrams for explaining a method of manufacturing a heat transport device according to a second embodiment of the present invention. As shown in FIG. 8(A), on a vessel-shaped lower plate member 203 of a heat transport device 200, an upper plate member 201 having a convex bonding surface 201a is placed. FIG. 8(B) schematically shows the contact area Z of the bonding surface 201a and a bonding surface 231 of the lower plate member 203.

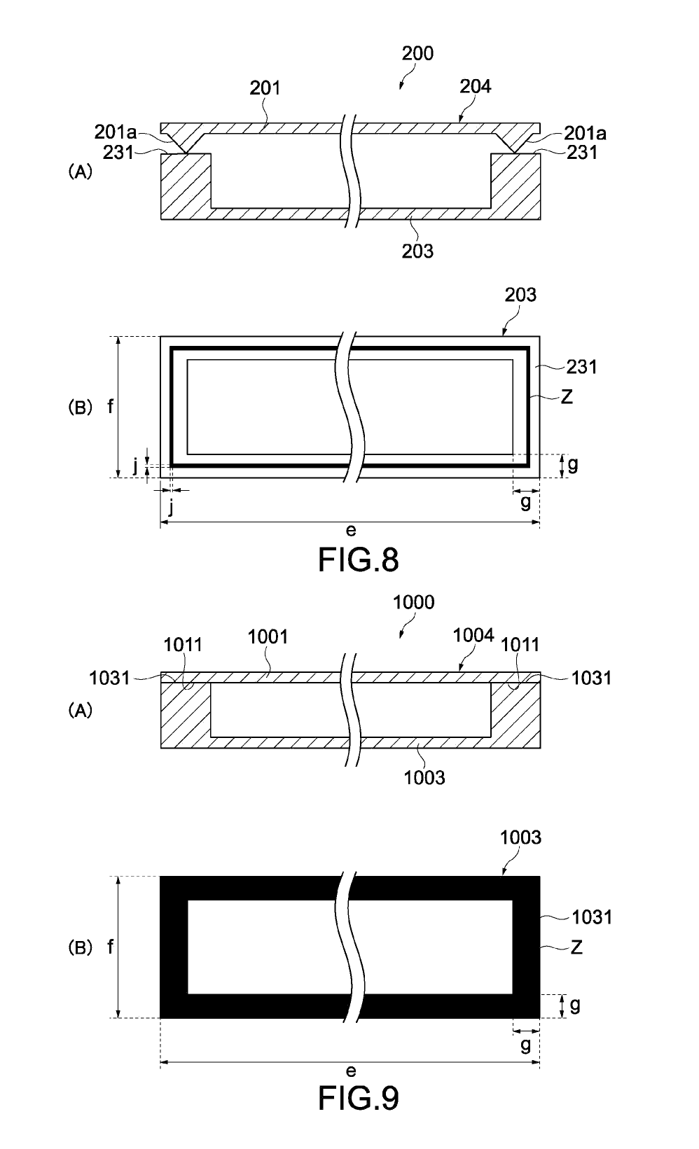

FIG. 9 are diagrams for explaining a method of manufacturing a heat transport device as a comparison target. As shown in FIG. 9(A), on a lower plate member 1003 of a heat transport device 1000, an upper plate member 1001 having a bonding surface 1011 that is not a convex shape is placed. FIG. 9(B) schematically shows the contact area Z of the bonding surface 1011 and a bonding surface 1031 of the lower plate member 1003.

Here, the size of the bonding surface 231 shown in FIG. 8(B) and the size of the bonding surface 1031 shown in FIG. 9(B) are set to be the same, and a size f in a short-side direction, a size e in a longitudinal direction, and a size g are set to 5 cm, 20 cm, 5 mm, respectively. In addition, a width j of the contact area Z shown in FIG. 8(B) is set to 100 μm. In this case, the area of the contact area Z of the bonding surface 201a and the bonding surface 231 in the heat transport device 200 is 0.5 cm², and the area of the contact area Z of the bonding surface 1011 and the bonding surface 1031 in the heat transport device 1000 is 24 cm². Those numerical values are set for convenience of explanation and do not limit the size of the heat transport device 200.

The entire load of 100 kgf is equally applied to the heat transport devices 200 and 1000. As a result, a pressure applied to the bonding surfaces 201a and 231 becomes 200 kgf/cm² (20 MPa), and a pressure applied to the bonding surfaces 1011 and 1031 becomes 4.2 kgf/cm² (0.42 MPa). That is, the container 204 of the heat transport device 200 according to this embodiment is formed by the diffusion bonding by the higher pressure, with the result that the hermeticity becomes higher. In addition, the reduction in yield due to the void caused in the diffusion bonding process can be prevented.

To form a container 1004 of the heat transport device 1000 as the comparison target by the higher pressure (20 MPa) as in the case of the container 204, it is necessary to apply the entire load of 50 times 100 kgf, i.e., about 5 tf to the upper plate member 1001 and the lower plate member 1003. However, it is difficult to uniformly apply a large load, so unevenness may occur in the load applied to the upper plate member 1001 and the lower plate member 1003. If the unevenness occurs, the bonding condition between the upper plate member 1001 and the lower plate member 1003 becomes also uneven, which may impair the hermeticity of the heat transport device 1000. In addition, an issue of the cost of an apparatus for generating the large load is caused.

In a case where the container is formed by the diffusion bonding using the lower pressure as in the heat transport device 1000, the diffusion bonding takes a longer time. However, in the method of manufacturing a heat transport device according to the embodiments of the present invention, the time taken for the diffusion bonding can be saved. This point will be described next.

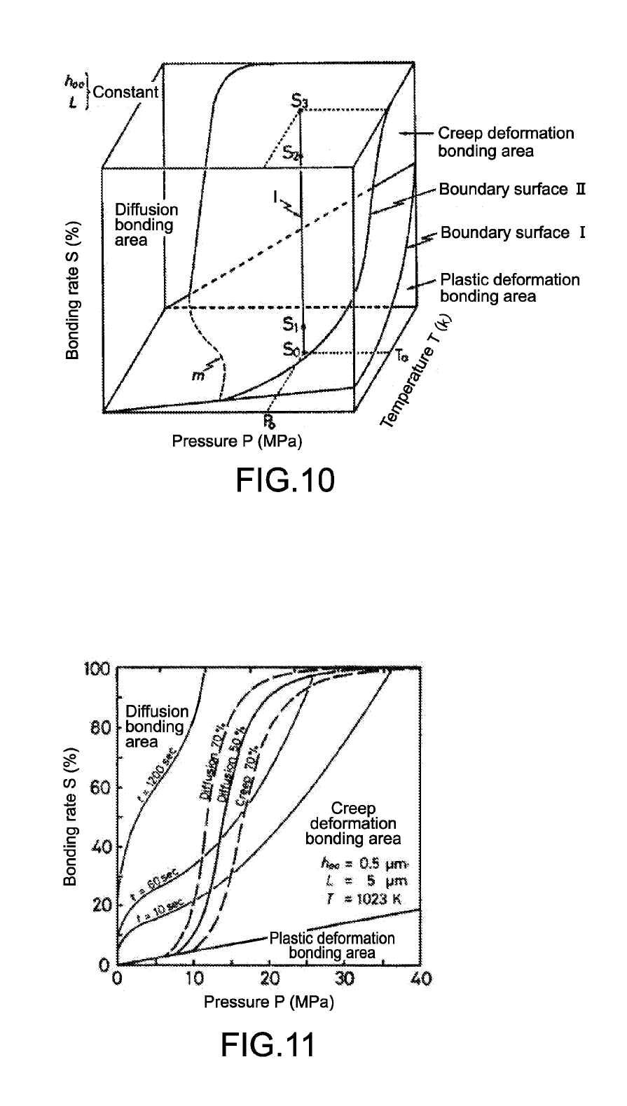

FIG. 10 is a graph explaining a bonding process in a case where two members are subjected to the diffusion bonding (see, p. 311 to p. 316, vol. 4, Analysis of the Solid State Bonding Process by the Diagrams of Bonding Mechanisms (1996) written by Nishiguchi, et al, Collection of Papers of Japan Welding Society). For the two members that are subjected to the diffusion bonding, copper is used. An interval L and a height h₀₀ of the unevenness due to the roughness of a surface of copper are set to be constant.

S₀ shown in FIG. 10 indicates a start point (bonding rate 0%) of the diffusion bonding at a pressure P₀ and a temperature T₀. Along a line 1 that vertically extends from S₀, the diffusion bonding advances and ends at S₃ (bonding rate 100%).

Further, the graph of FIG. 10 shows three areas of a plastic deformation bonding area, a creep deformation bonding area, and a diffusion bonding area. The three areas will be described.

The bonding mechanism of the diffusion bonding is roughly classified into three mechanisms, a plastic deformation bonding mechanism, a creep deformation bonding mechanism, and a diffusion bonding mechanism. The plastic deformation bonding mechanism and the creep deformation bonding mechanism refer to a mechanism that gives mechanical strain to a vicinity of the bonding surface, thereby causing deformation and close contact of the bonding surfaces with each other. The plastic deformation bonding mechanism is a mechanism that operates only at the start of the bonding, and the creep deformation bonding mechanism is a mechanism that is operating during the bonding process thereafter. The diffusion bonding mechanism is a mechanism that causes the bonding surfaces to be bonded to each other by the diffusion of atoms. Those bonding mechanisms individually contribute to the bonding process of the diffusion bonding.

The areas shown in FIG. 10 each indicate a bonding mechanism that makes the greatest contribution to the bonding process of the diffusion bonding in the area. For example, in a case where a point on the line 1 mentioned above is in the creep deformation bonding area, the bonding mechanism that makes the greatest contribution to the bonding process is the creep deformation bonding mechanism.

S₁ is a point on a boundary surface I. The boundary surface I indicates the end of the plastic deformation bonding mechanism. In an area above the boundary surface I, by the creep deformation bonding mechanism and the diffusion bonding mechanism, the diffusion bonding is advanced. S₂ is on a boundary surface II, which indicates that the contribution rates of the creep deformation bonding mechanism and the diffusion bonding mechanism are 50%, respectively. Accordingly, the diffusion bonding at the pressure P₀ and temperature T₀ is advanced, with the plastic deformation bonding mechanism (S₀-S₁), the creep deformation bonding mechanism (S₁-S₂), and the diffusion bonding mechanism (S₂-S₃) providing the greatest contribution rate in this order. As shown in FIG. 10, when the temperature T is constant, as the pressure P used for the diffusion bonding becomes larger, the diffusion bonding is advanced while passing through a larger part of the creep deformation bonding area. When the diffusion bonding is advanced by the small pressure P while passing through an area on the left of a curve m, the contribution rate of the creep deformation bonding mechanism is small.

FIG. 11 is a graph showing a relationship among the pressure, the bonding rate, and the bonding mechanism that provides the largest contribution rate in a case where the temperature is set to be constant. FIG. 11 shows a curve (hereinafter, referred to as isochrone) that indicates an equal elapsed time t from the start of bonding and a curve that indicates the contribution rates of the creep deformation bonding mechanism and the diffusion bonding mechanism. The temperature T, and the height h₀₀ and the interval L of the unevenness of the surface of copper subjected to the diffusion bonding are constant and set to 1023 K, 0.5 μm, and 5 μm, respectively.

As shown in FIG. 11, as the pressure P becomes higher, the isochrone increases, meaning that the higher the pressure P, the larger the bonding rate at the equal elapsed time t. In other word, the diffusion bonding by using a high pressure P, in which a larger part of the creep deformation bonding area is passed, is advanced in a shorter time. Thus, it can be found that the diffusion bonding by using the high pressure (20 MPa) in the method of manufacturing the heat transport device 200 described above is advanced in a short time.

[Method of Manufacturing Heat Transport Device According to Third Embodiment]

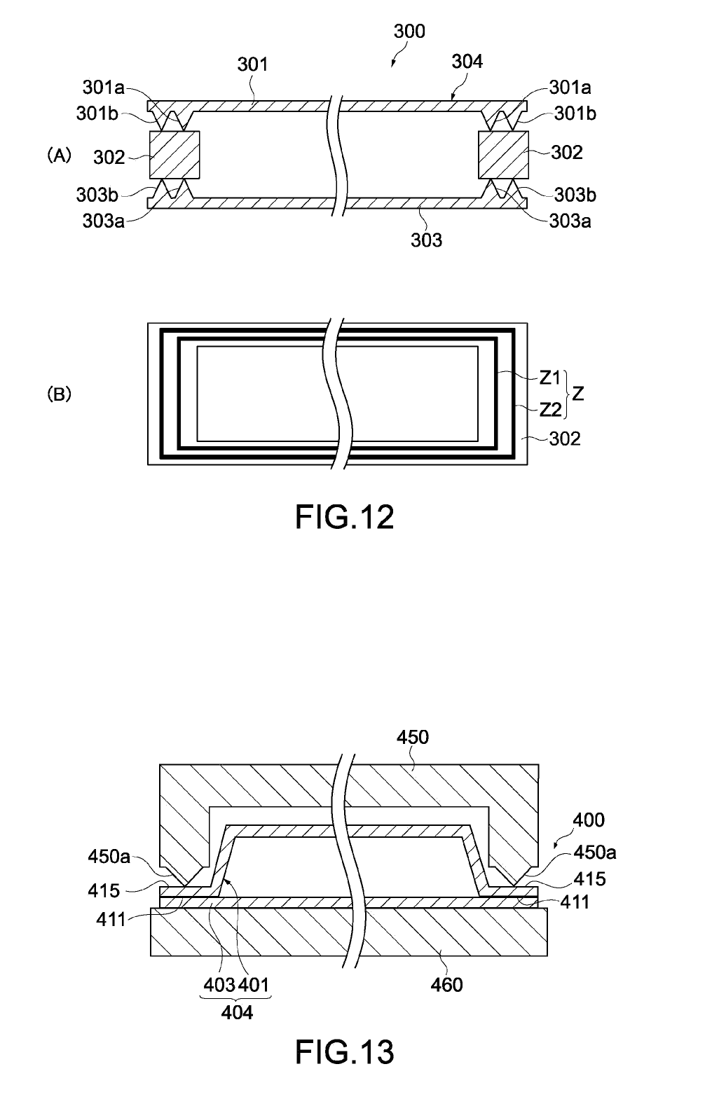

FIG. 12 are diagrams for explaining a method of manufacturing a heat transport device according to a third embodiment of the present invention. In a heat transport device 300 according to this embodiment, a plurality of convex bonding surfaces are provided on an upper plate member 301 and a lower plate member 303. As shown in FIG. 12(A), convex bonding surfaces 301a and 301b are provided on the upper plate member 301, and convex bonding surfaces 303a and 303b are provided on the lower plate member 303. FIG. 12(B) is a diagram showing a contact area Z1 of the bonding surface 301a and a frame member 302 and a contact area Z2 of the bonding surface 301b and the frame member 302. The contact area Z1 is surrounded by the contact area Z2.

The bonding surfaces 301a and 301b are subjected to the diffusion bonding to the frame member 302 by a high pressure, thereby forming a part of a sidewall of a container 304. The bonding surfaces 301a and 301b that function as the part of the sidewall multiply surrounds an inside space of the container 304, which can make the percentage of leak failure lower. The same holds true for the bonding surfaces 303a and 303b.

The bonding surfaces 301a and 301b are deformed in the diffusion bonding process and are respectively increased in width. When the sum of the widths of the bonding surfaces 301a and 301b deformed falls within a range of 100 μm to 1 cm as described above, the leak failure can be sufficiently prevented.

[Method of Manufacturing Heat Transport Device According to Fourth Embodiment]

FIG. 13 is a diagram for explaining a method of manufacturing a heat transport device using jig portions according to a fourth embodiment of the present invention.

As a material of jig portions 450 and 460, carbon or stainless steel is generally used.

On the jig portion 460, a lower plate member 403 is placed. On the lower plate member 403, an upper plate member 401 is placed. On the upper plate member 401, the vessel-shaped jig portion 450 having a convex portion 450a is placed. The convex portion 450a is placed on a surface 415 on the opposite side of a bonding surface 411 of the upper plate member 401, which is bonded to the lower plate member 403.

When the entire load is applied in a direction in which the jig portion 450 and the heat transport device 400 are placed, a high pressure is applied to the surface 415 of the upper plate member 401 by the convex portion 450a. By the high pressure, the surface 415 and the bonding surface 411 are formed into a convex shape. Further, by the high pressure, the bonding surface 411 formed into the convex shape and the lower plate member 403 are subjected to the diffusion bonding, and the bonding surface 411 forms a part of the sidewall of the container 404.

In this embodiment, there is no need to provide a convex bonding surface on the upper plate member 401 in advance, which can cut the cost. In addition, it is possible to prevent the reduction in yield due to an error or the like in forming the convex bonding surface in a case where the convex bonding surface is provided in advance.

[Method of Manufacturing Heat Transport Device According to Fifth Embodiment]

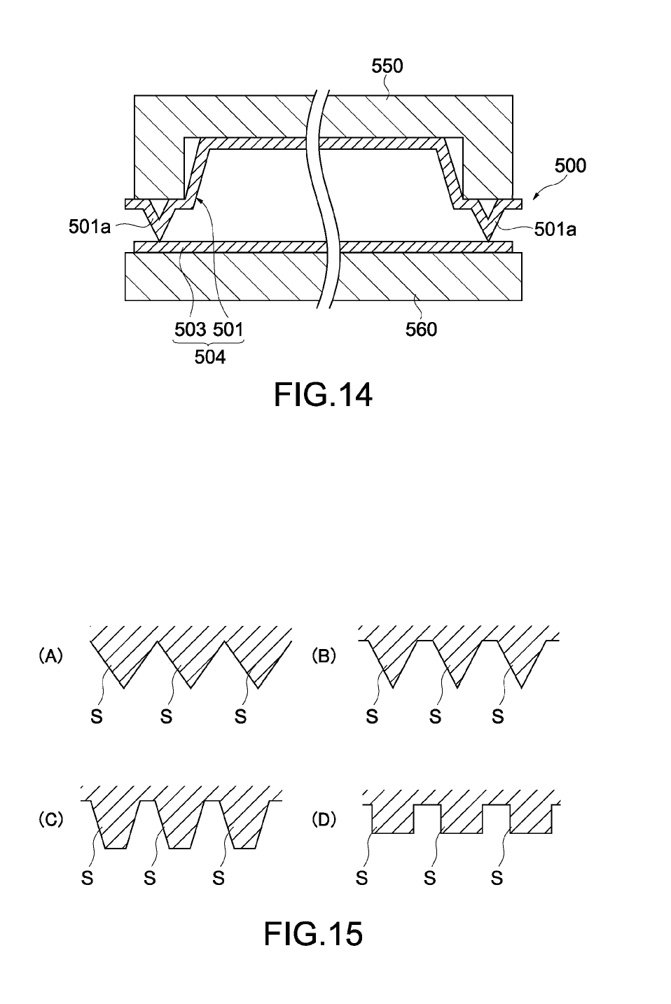

FIG. 14 is a diagram for explaining a method of manufacturing a heat transport device according to a fifth embodiment of the present invention.

On a jig portion 560, a lower plate member 503 is placed. On the lower plate member 503, an upper plate member 501 having a convex bonding surface 501a is placed. Further, on the upper plate member 501, a vessel-shaped jig portion 550 is placed. Next, the entire pressure is applied in a direction in which the jig portion 550 and the heat transport device 500 are placed, and the upper plate member 501 and the lower plate member 503 are subjected to the diffusion bonding. By the convex bonding surface 501a, the upper plate member 501 and the lower plate member 503 are subjected to the diffusion bonding by the higher pressure.

### Specific Shape Example of Convex Bonding Surface

FIG. 15 are cross-sectional diagrams showing specific shape examples of the convex bonding surface. Here, examples in which three convex bonding surfaces S having the same shape are provided are given.

In each of FIGS. 15(A) and 15(B), an end portion of the bonding surface S that is contacted with another member has a pointed shape. In each of FIGS. 15(C) and 15(D), an end portion is a surface shape that is approximately parallel to a bonding surface of another member. In addition, in the case where the plurality of convex bonding surface diagrams S are provided, an interval may be provided between adjacent convex bonding surfaces S as shown in FIGS. 15(B), 15(C), and 15(D), or an interval may not be provided as shown in FIG. 15(A).

The shapes are not limited to the shapes shown in FIG. 15. Any shape may be used as long as such a shape that a contact area with another member in the diffusion bonding process becomes small is used. Further, a plurality of bonding surfaces having shapes different from each other may be provided. If the width of the bonding surface (or total widths of the plurality of bonding surfaces) that has been subjected to the diffusion bonding and deformation falls within the range of 100 μm to 1 cm, the hermeticity of the container of the heat transport device can be sufficiently maintained.

### Modified Example

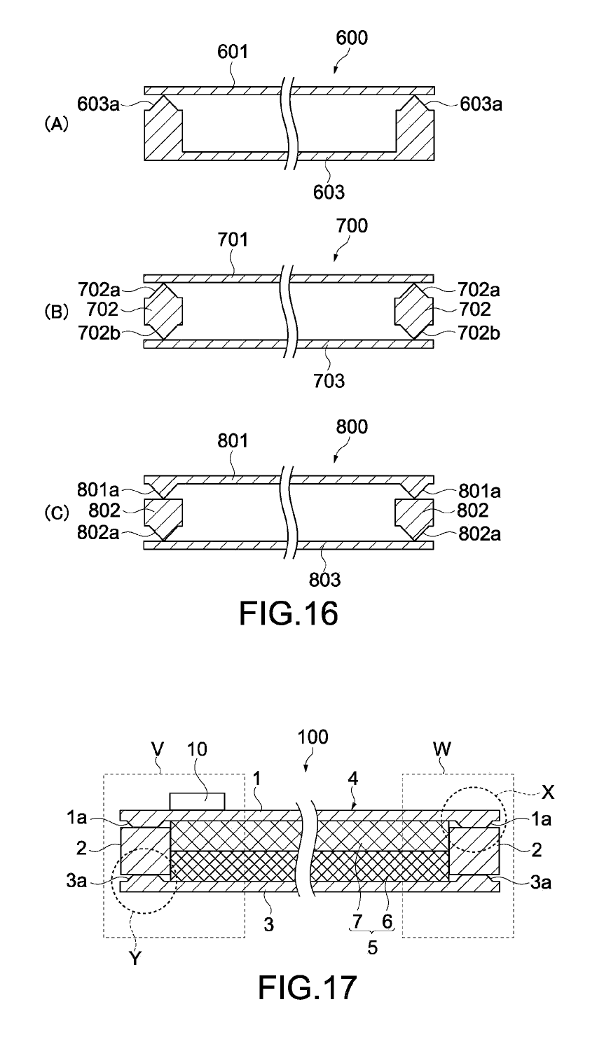

The present invention is not limited to the above embodiments and may be variously modified without departing from the gist of the present invention. For example, as shown in FIG. 16, portions on which the convex bonding surfaces are provided may be set as appropriate.

FIG. 16(A) is a diagram showing a state in which a bonding surface 603a of a vessel-shaped lower plate member 603, which is subjected to the diffusion bonding to an upper plate member 601, is formed into a convex shape.

FIG. 16(B) is a diagram showing a state in which a bonding surface 702a and a bonding surface 702b of a frame member 702 are each formed into a convex shape, the bonding surfaces 702a and 702b being subjected to the diffusion bonding to an upper plate member 701 and an lower plate member 703, respectively.

FIG. 16(C) is a diagram showing a state in which a bonding surface 801a of an upper plate member 801 and a bonding surface 802a of a frame member 802 are each formed into a convex shape, the bonding surfaces 801a and 802a being subjected to the diffusion bonding to the frame member 802 and a lower plate member 803, respectively.

### Sixth Embodiment

Next, a sixth embodiment of the present invention will be described.

In the above embodiments, the description is given on the case where the container is formed of the upper plate member, the lower plate member, and the like. On the other hand, in the sixth embodiment, a container is formed by bending one plate member. Therefore, this point will be mainly described.

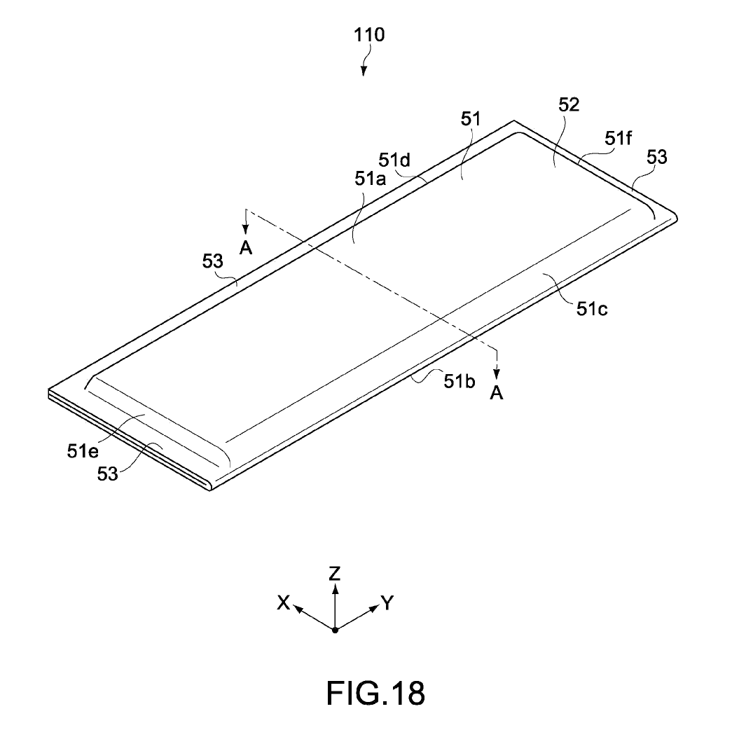

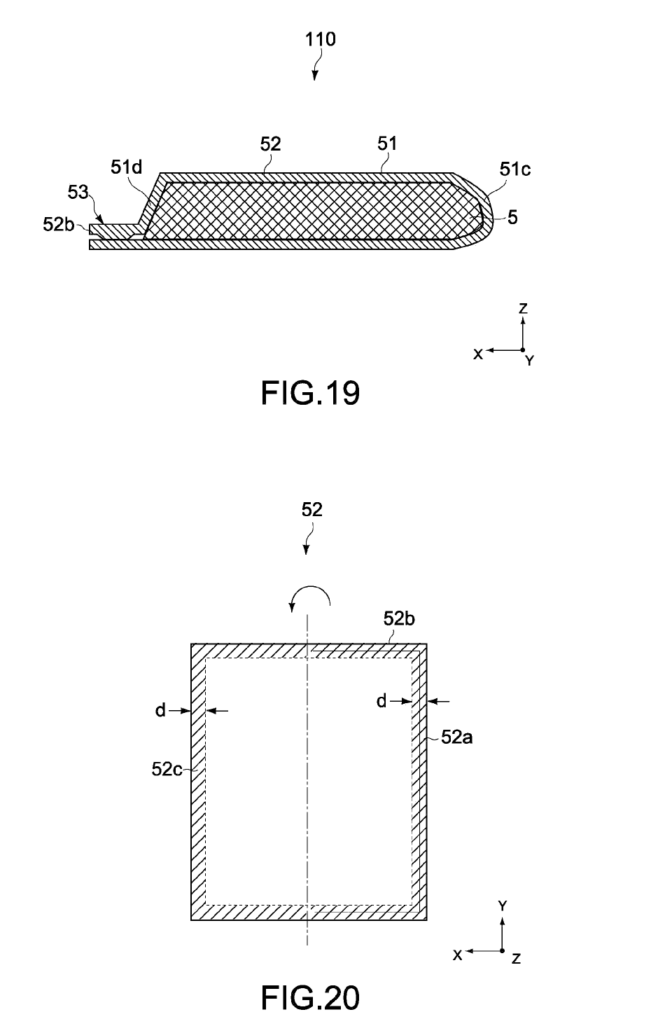

FIG. 18 is a perspective view showing a heat transport device according to the sixth embodiment. FIG. 19 is a cross-sectional view of the heat transport device taken along the line A-A of FIG. 18. FIG. 20 is a development view of a plate member that forms a container of the heat transport device.

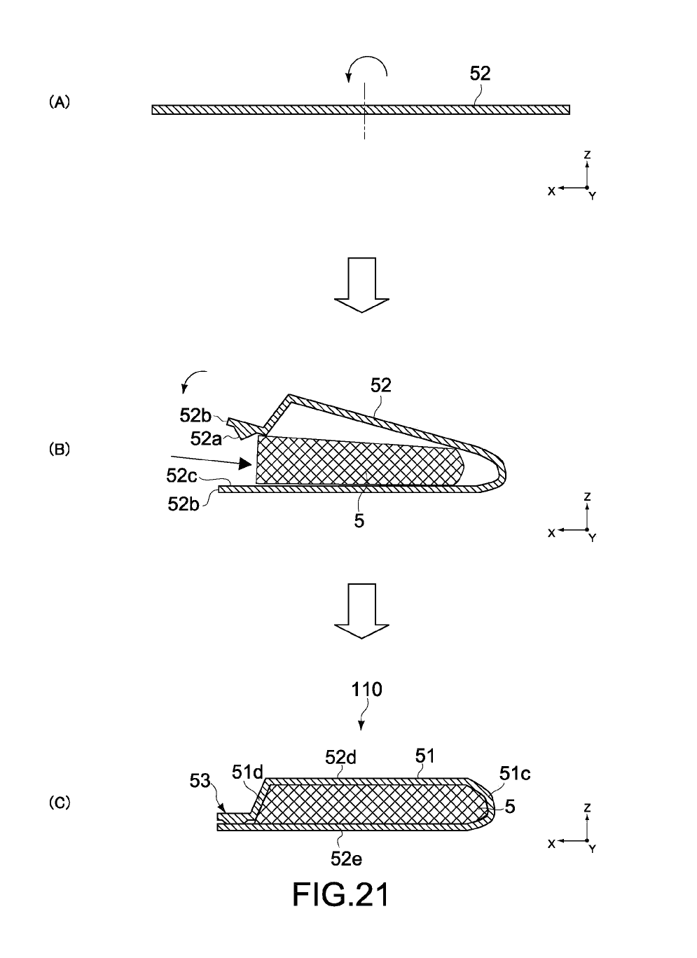

As shown in FIG. 18, a heat transport device 110 includes a container 51 having a rectangular, thin plate shape that is long in one direction (Y-axis direction). The container 51 is formed by bending one plate member 52. As shown in FIGS. 20 and 21(B), a convex bonding surface 52a is provided in an area that is a predetermined distance d away from an edge portion 52b of the plate member 52 inwardly in the half of the plate member 52 with respect to a centerline of the plate member 52. Further, a flat bonding surface 52c to which the bonding surface 52a is contacted and bonded by the diffusion bonding is provided in an area that is the predetermined distance d away from the edge portion 52b inwardly in the other half of the plate member 52 with respect to the centerline of the plate member 52. That is, as shown in FIG. 20, a perimeter portion of the plate member 52 corresponds to a bonding area.

Generally, the plate member 52 is made of oxygen-free copper, tough pitch copper, or a copper alloy. However, the material is not limited to those. The plate member 52 may be made of metal other than copper or may instead be made of a material having high heat conductivity.

As shown in FIGS. 18 and 19, the container 51 includes a side portion 51c along a longitudinal direction (Y-axis direction) having a curved shape. That is, the container 51 is formed by bending the plate member 52 shown in FIG. 20 with respect to approximately the centerline of the plate member 52. Therefore, the side portion 51c is curved. Hereinafter, the side portion 51c may be referred to as a curve portion 51c in some cases.

In the container 51, the capillary member 5 is provided. The capillary member 5 includes one or more mesh members 8 as described above.

[Method of Manufacturing Heat Transport Device 110]

FIG. 21 are diagrams showing a method of manufacturing a heat transport device.

As shown in FIG. 21(A), the plate member 52 is prepared first. Then, with respect to approximately the centerline of the plate member 52, the plate member 52 is bent.

When the plate member 52 is bent by a predetermined angle, the capillary member 5 is disposed inside the plate member 52 bent as shown in FIG. 21(B). It should be noted that the capillary member 5 may be disposed at a predetermined position on the plate member 52 before the plate member 52 is started to be bent. When the capillary member 5 is disposed inside the plate member 52, the plate member 52 is further bent so that the capillary member 5 is enclosed. As a result, the bonding surface 52a and the bonding surface 52c are opposed to each other. Further, as shown in FIG. 21(C), a bonding portion 53 of the plate member 52 bent is pressurized, thereby bonding the bonding surface 52a and the bonding surface 52c to each other by the diffusion bonding. The portion pressurized by the diffusion bonding is the bonding portion 53 shown in FIG. 18, which corresponds to three sides of the four sides of the end portions of the square. In addition, in the diffusion bonding process, as shown in FIG. 21(C), the capillary member 5 is bonded to an upper plate portion 52d and a lower plate portion 52e of the plate member 52 by the diffusion bonding.

In the case of the heat transport device 110, the container 51 is formed of the one plate member 52, and therefore the number of parts is reduced, which can cut the cost. Further, in a case where the container 51 is formed of two or more members, it is necessary to position those members with respect to each other. But, in this embodiment, there is no need to position the members. Accordingly, the heat transport device 110 can be easily manufactured.

### Modified Example

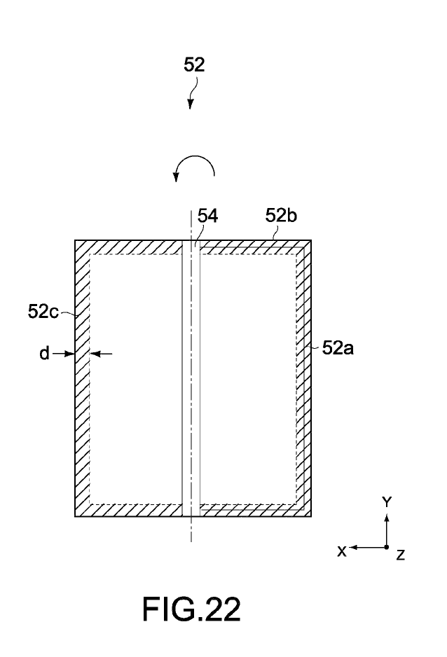

FIG. 22 is a development view of the plate member for explaining a modified example of the heat transport device 110.

As shown in FIG. 22, the plate member 52 has a groove 54 along the longitudinal direction (Y-axis direction) in the center of the plate member 52. The groove 54 is formed by the press process or the etching process, for example, but the method of forming the groove 54 is not particularly limited.

The groove 54 is formed on the plate member 52, which can cause the plate member 52 to be easily bent. As a result, the heat transport device 110 can be more easily manufactured. It should be noted that the plate member 52 may be bent along the short side (in the short-side direction) (with the X direction being as the axis), although there has been shown the structure in which the plate member 52 is bent along the longitudinal direction (with the Y direction being the axis).

### Seventh Embodiment

Next, a seventh embodiment of the present invention will be described. It should be noted that in the seventh embodiment, points different from the sixth embodiment described above will be mainly described.

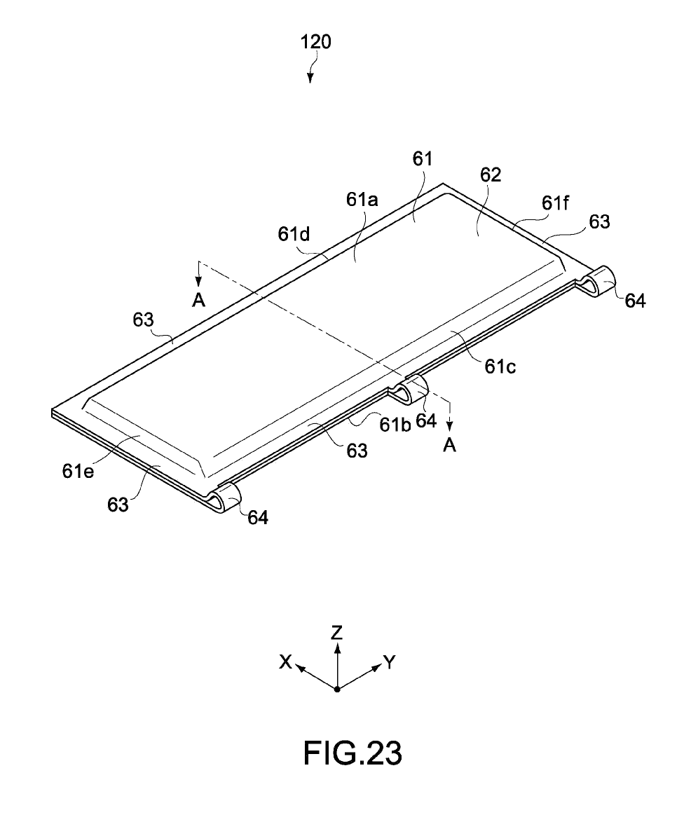

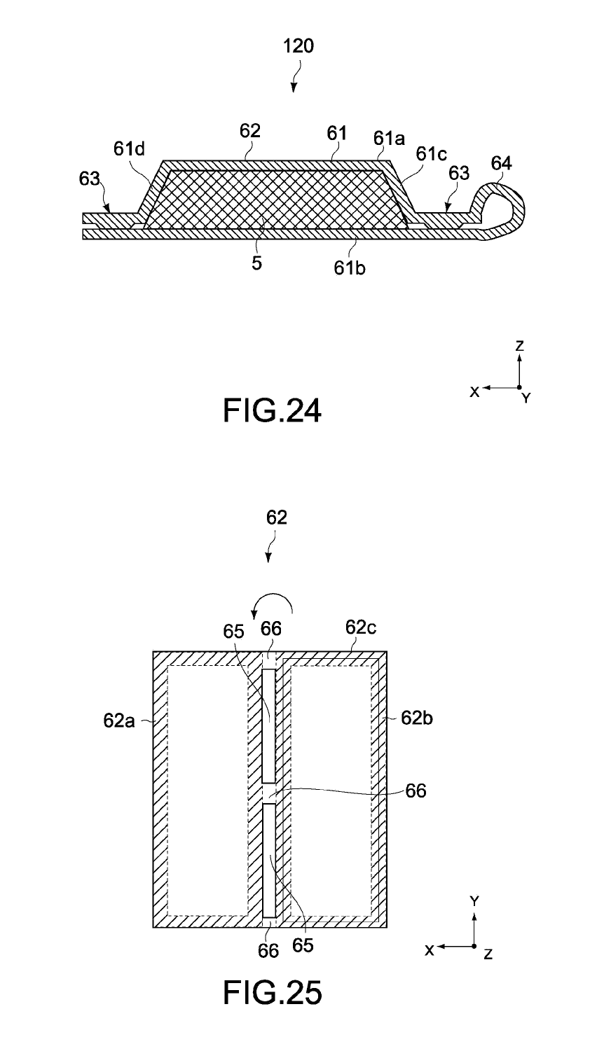

FIG. 23 is a perspective view showing a heat transport device according to the seventh embodiment. FIG. 24 is a cross-sectional view of the heat transport device taken along the line A-A of FIG. 23. FIG. 25 is a development view of a plate member that forms a container of the heat transport device.

As shown in FIG. 23 and FIG. 24, a heat transport device 120 includes a container 61 having a rectangular, thin plate shape that is long in one direction (Y-axis direction).

The container 61 is formed by folding over a plate member 62 shown in FIG. 25 with respect to the centerline. The plate member 62 has two openings 65 along the longitudinal direction of the plate member 62 in the center of the plate member 62. By forming the openings 65, a form in which the left-side plate and the right-side plate of the plate member 62 are connected through three areas 66 is obtained.

The container 61 has a bonding portion 63 in side portions 61c and 61d in a direction along the longitudinal direction (Y-axis direction) and in side portions 61e and 61f in a direction along the short-side direction (X-axis direction). In the bonding portion 63, a bonding surface 62a and a convex bonding surface 62b indicated by the shaded area are bonded by the diffusion bonding, thereby forming the container 61.

As the result of the bonding of the upper plate and the lower plate as described above, three protrusion portions 64 that are protruded from the side portion 61c.

In the heat transport device 120, the openings 65 are formed in the plate member 62, and therefore the plate member 62 can be easily bent. As a result, the heat transport device 120 can be more easily manufactured.

In the areas 66 between the openings 65 and edge portion 62c and the area 66 between the two openings 65, a groove formed by the press process or the like may be provided. With the groove, the plate member 62 can be more easily bent.

Any one of the features of the embodiments shown in FIG. 18 and the subsequent figures and any one of the features of the embodiments shown in FIGS. 12 to 15 may be combined.

### DESCRIPTION OF SYMBOLS

1, 201, 301, 401, 501, 601, 701, 801, 901, 1001 upper plate member
1a, 3a, 201a, 301a, 301b, 303a, 303b, 501a, 601a, 702a, 702b, 801a, 802a convex bonding surface
2, 302, 702, 802 frame member
3, 203, 303, 403, 503, 603, 703, 803, 903, 1003 lower plate member
4, 204, 304, 404, 904, 1004 container
5 capillary member
6 first mesh layer
7 second mesh layer
8 mesh member
10 heat source
21, 23 bonding surface of frame member
100, 200, 300, 400, 500, 900, 1000 heat transport device
231, 931, 1031 bonding surface of lower plate member
411, 911, 1011 bonding surface of upper plate member
415 surface of upper plate member
450a convex portion of jig portion
450, 460, 550, 560 jig portion
950 void

1. A method of manufacturing a heat transport device, comprising:
causing a convex bonding surface of a first plate that forms a container of a heat transport device to be opposed to a bonding surface of a second plate that forms the container, the heat transport device transporting heat by using a phase change of a working fluid, the convex bonding surface forming a part of a sidewall that surrounds an inside space of the container; and
performing diffusion bonding of the bonding surface of the first plate to the bonding surface of the second plate to form the container.

2. The method of manufacturing a heat transport device according to claim 1,
wherein the first plate includes a plurality of convex bonding surfaces.

3. The method of manufacturing a heat transport device according to claim 2,
wherein the diffusion bonding process deforms the plurality of convex bonding surfaces.

4. The method of manufacturing a heat transport device according to claim 3,
wherein the plurality of convex bonding surfaces deformed have a total width of 100 μm to 1 cm.

5. The method of manufacturing a heat transport device according to claim 1, further comprising:
forming the convex bonding surface by a mechanical polishing, an etching, or a molding process.

6. The method of manufacturing a heat transport device according to claim 1,
wherein the diffusion bonding process deforms the convex bonding surface.

7. The method of manufacturing a heat transport device according to claim 6,
wherein the convex bonding surface deformed has a width of 100 μm to 1 cm.

8. A method of manufacturing a heat transport device, comprising:
causing a convex bonding surface of a first plate that forms a container of a heat transport device to be opposed to a first bonding surface of a frame member that forms a sidewall that surrounds an inside space of the container, the heat transport device transporting heat by using a phase change of a working fluid, the convex bonding surface forming a part of the sidewall;
causing a bonding surface of a second plate that forms the container to be opposed to a second bonding surface of the frame member, the second bonding surface being on an opposite side to the first bonding surface; and
performing diffusion bonding of the bonding surface of the first plate to the first bonding surface and performing diffusion bonding of the bonding surface of the second plate to the second bonding surface to form the container.

9. The method of manufacturing a heat transport device according to claim 8,
wherein the bonding surface of the second plate is formed to be convex to form a part of the sidewall.

10. A method of manufacturing a heat transport device, comprising:
causing a bonding surface of a first plate that forms a container of a heat transport device to be opposed to a convex first bonding surface of a frame member that forms a sidewall that surrounds an inside space of the container, the heat transport device transporting heat by using a phase change of a working fluid, the convex first bonding surface forming a part of the sidewall;
causing a bonding surface of a second plate that forms the container to be opposed to a second bonding surface of the frame member, the second bonding surface being on an opposite side to the first bonding surface; and
performing diffusion bonding of the bonding surface of the first plate to the first bonding surface and performing diffusion bonding of the bonding surface of the second plate to the second bonding surface to form the container.

11. The method of manufacturing a heat transport device according to claim 10,
wherein the second bonding surface of the frame member is formed to be convex to form a part of the sidewall.

12. A method of manufacturing a heat transport device, comprising:
layering a jig portion, a first plate, and a second plate so that a bonding surface of the first plate that forms a container of a heat transport device is caused to be opposed to a bonding surface of the second plate that forms the container and an annular convex portion of the jig portion is caused to face the first plate from an opposite side of the bonding surface of the first plate, the heat transport device transporting heat by using a phase change of a working fluid;
forming, by applying a load to the jig portion, the first plate, and the second plate in a direction of the layering, the bonding surface of the first plate to be convex by the convex portion so that the bonding surface of the first plate is formed as a part of a sidewall that surrounds an inside space of the container; and
performing diffusion bonding of the bonding surface of the first plate to the bonding surface of the second plate by using the load to form the container.

13. A method of manufacturing a heat transport device, comprising:
sandwiching a capillary member by a first portion and a second portion of a plate that are formed by bending the plate, the plate forming a container of a heat transport device that transports heat by using a phase change of a working fluid, the capillary member applying a capillary force to the working fluid;
causing a convex bonding surface formed on the first portion to be opposed to a bonding surface of the second portion to form a part of a sidewall that surrounds an inside space of the container; and
performing diffusion bonding of the bonding surface of the first portion to the bonding surface of the second portion to form the container.

14. A heat transport device, comprising:
a container that has a sidewall surrounding an inside space, the container including a first plate and a second plate, the first plate having a convex bonding surface to form a part of the sidewall, the second plate being bonded to the convex bonding surface by diffusion bonding; and
a working fluid to transport heat by a phase change in the container.

15. The heat transport device according to claim 14,
wherein the first plate has a plurality of convex bonding surfaces.

16. A heat transport device, comprising:
a container that has a sidewall surrounding an inside space, the container including a first plate, a frame member, and a second plate, the first plate having a convex bonding surface to form a part of the sidewall, the frame member having a first bonding surface bonded to the convex bonding surface by diffusion bonding and forming the sidewall, the second plate being bonded to the second bonding surface by diffusion bonding, the second bonding surface being on an opposite side to the first bonding surface of the frame member; and
a working fluid to transport heat by a phase change in the container.

17. The heat transport device according to claim 16,
wherein the second plate has a convex bonding surface to form a part of the sidewall, the convex bonding surface being bonded to the second bonding surface of the frame member by the diffusion bonding.
